(19) United States
(12) Patent Application Publication
(10) Pub. No.: US 2017/0067233 A1
(43) Pub. Date: Mar. 9, 2017

(54) SYSTEM FOR PREVENTING CONTAMINANT INTRUSION IN WATER SUPPLY NETWORKS

(71) Applicant: KING FAHD UNIVERSITY OF PETROLEUM AND MINERALS, Dhahran (SA)

(72) Inventor: ASHRAF M. S. FARAHAT, KELOWNA (CA)

(21) Appl. No.: 14/848,133

(22) Filed: Sep. 8, 2015

(51) Int. Cl. E03B 7/07; G05D 16/20; E03B 7/02

(52) U.S. Cl. CPC E03B 7/074; E03B 7/077; E03B 7/02; G05D 16/2066

(57) ABSTRACT

The system for preventing contaminant intrusion in water supply networks having at least one water reservoir and a plurality of interconnected underground water supply pipes extending therefrom includes at least one pneumatic pump and at least one water pressure sensor which communicate with the pipes. The pump draws ambient air from the atmosphere and pumps that air into one or more of the pipes under pressure, in the event that the sensor detects a water pressure below a predetermined threshold within the pipes. Thus, the pressure within the pipe(s) remains higher than the ambient pressure of the material surrounding the pipe(s), to prevent the incursion of microbes, chemicals, and/or other foreign matter into the water supply pipe(s) through any cracks, imperfect joints, and/or other discontinuities in the pipe walls.

### BACKGROUND OF THE INVENTION

1. Field of the Invention

The present invention relates generally to fluid supply systems, and particularly to a system for preventing contaminant intrusion in water supply networks. The system provides pneumatic pressure higher than external pressures surrounding water supply lines, to prevent the flow of contaminants and/or other materials into the water supply.

2. Description of the Related Art

Public water systems are provided throughout the world in practically all cities, towns, and communities where there is a significant population. Many other entities have their own water systems, e.g., military bases, large industrial complexes, etc. It is of course critical that these water supplies remain uncontaminated by microorganisms, chemicals, and/or other potentially adverse contaminants.

One of the major sources of water contamination in such systems is the occurrence of negative pressure events, i.e., the pressure within the water pipe or conduit becomes less than the pressure of the medium surrounding the pipe. This may be due to a break in a water main, failure of a pump in the system or the shutdown of such a pump for maintenance, or for various other reasons. Such pressure drops within the system can result in contamination of the water supply within the pipe due to inflow of contaminants through cracks, leaking joints, and/or other imperfections in the pipes of the water supply system. While nearly all such water systems continuously monitor the pressures within the pipes of the system, such monitoring can only provide a warning and does nothing to prevent the incursion of potentially lethal microorganisms and/or chemicals into the water supply in the event that water pressure in the system drops below external pressure at any given point(s) in the system.

Accordingly, various systems have been developed in the past to prevent contamination of water supplies in the event of pressure drops in the systems. An example is found in Chinese Patent Publication No. 2835363 published on Nov. 8, 2008 to Wang Daoguang. This reference describes (according to the drawings and English abstract) a system for maintaining positive pressure in a water supply, the system having a water supply tank that receives water from the water supply during normal operation. Water in the tank is delivered into the water supply to maintain positive pressure therein in the event of a pressure drop.

Chinese Patent Publication No. 203222846 published on Oct. 2, 2013 to Wang Runming describes (according to the drawings and English abstract) a system similar to that described in the '363 Chinese Patent Publication cited immediately above. i.e., having a water tank or reservoir that is filled from the water supply during normal operation and that releases the stored water in the event of a pressure drop in the system.

European Patent Publication No. 2666718 published on Oct. 2, 2013 to Siemens AG describes (according to the drawings and English abstract) a system incorporating a water supply tank or reservoir with a closed air volume above the water. The water is supplied from the water supply system, as in the Chinese references noted above. The air in the reservoir serves as a means for pressurizing the water supply in the tank, and is not replenished from an external source.

Thus, a system for preventing contaminant intrusion in water supply networks solving the aforementioned problems is desired.

### SUMMARY OF THE INVENTION

The system for preventing contaminant intrusion in water supply networks includes at least one pneumatic pump and at least one pressure sensor communicating with the water supply network. The pressure sensor also communicates with the pump to activate the pump in the event that water pressure within the water supply network drops below a certain predetermined level, the predetermined level being at least slightly below the ambient pressure surrounding the water supply pipe at the location of the sensor.

When the sensor activates the pump, the pump draws ambient air from the atmosphere into the system and pumps that air into the water pipes to increase the pressure within the pipes to a level somewhat higher than the surrounding ambient pressure around the pipes. This prevents the inflow of any foreign matter, contaminants, etc. into the water supply system in the event that there are any cracks, imperfect joints, and/or other discontinuities in the pipes of the system that would otherwise permit flow from outside the pipe to within the pipe. The pneumatic pump may include an inlet filter(s) to filter the air entering the system in order to preclude the entry of undesired foreign matter into the system from the atmosphere. One or more such pneumatic pumps may be installed in a water supply system as desired, with one or more sensors communicating with each pump.

These and other features of the present invention will become readily apparent upon further review of the following specification and drawings.

### BRIEF DESCRIPTION OF THE DRAWINGS

FIG. 1 is a schematic diagram of a system for preventing contaminant intrusion in water supply networks according to the present invention, illustrating its features.

FIG. 2 is a detailed schematic diagram of the system for preventing contaminant intrusion in water supply networks according to the present invention, illustrating further details thereof.

FIG. 3 is a schematic diagram of a pump and check valve installation of the system for preventing contaminant intrusion in water supply networks according to the present invention, illustrating further details thereof.

FIG. 4 is a flow chart illustrating the basic steps in the operation of the system for preventing contaminant intrusion in water supply networks according to the present invention.

Similar reference characters denote corresponding features consistently throughout the attached drawings.

### DETAILED DESCRIPTION OF THE PREFERRED EMBODIMENTS

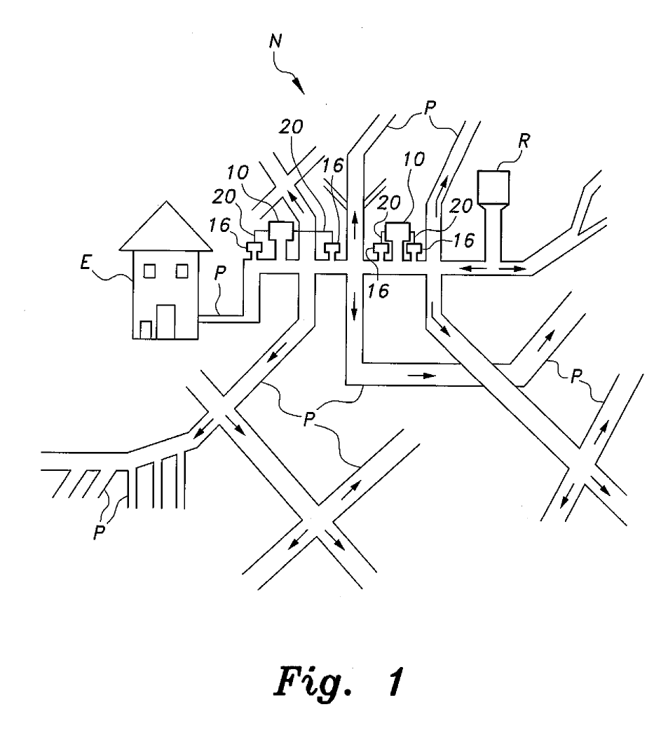

The system for preventing contaminant intrusion in water supply networks is an automated system for maintaining internal pressure within the water supply network at a higher pressure than the ambient pressure immediately external to the pipes of the network, thereby preventing inflow of undesired material into the pipe network. The system may be provided or installed in combination with a new or existing water supply network N, as shown particularly in FIG. 1 of the drawings and described in detail below.

FIG. 1 of the drawings provides a schematic diagram of a water supply network N having a plurality of mutually interconnected water supply pipes P. Water is supplied to the pipes P of the network N by a water supply reservoir R, e.g., elevated water tank, etc. One or more pumps (not shown) may be incorporated in such a system to increase the water pressure in the network N to a pressure higher than the pressure immediately external to the pipes P. Water is delivered under pressure to various end users E, e.g., the exemplary home or other structure illustrated schematically in FIG. 1. It will be understood that the supply network N would normally supply water to a plurality of such structures or end users E, with only a single end user structure E being shown in FIG. 1 for clarity in the drawings.

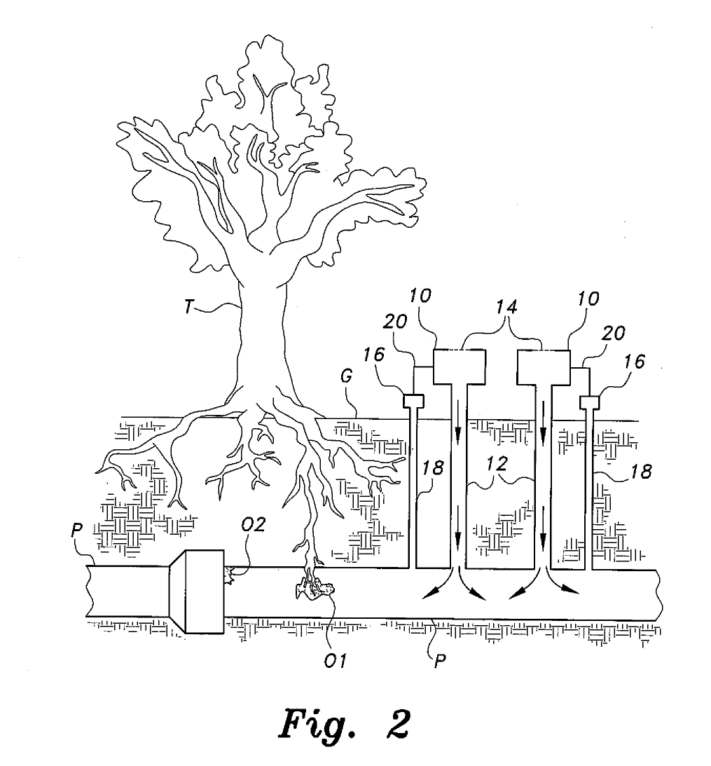

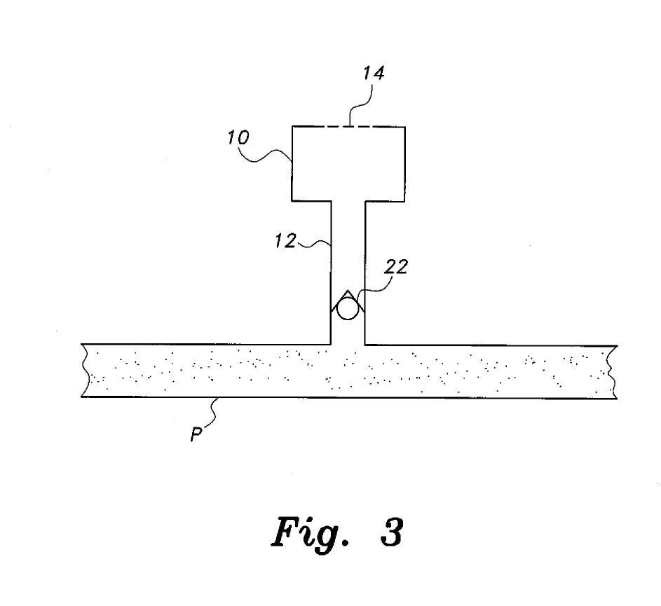

At least one, and preferably a plurality of, pneumatic pumps 10 can be included in the present system. The pneumatic pumps 10 are incorporated with the water supply network N and communicate pneumatically with one or more of the pipes P. Two such pumps 10 are illustrated in the schematic view of FIG. 1, with a more detailed representation being shown in FIG. 2. The pumps 10 are located above the surface or ground level G, as shown in FIG. 2, in order that they may draw ambient air as needed from the atmosphere. Each of the pumps 10 communicates pneumatically with a corresponding water supply pipe P by means of a pneumatic pipe or line 12 extending between the corresponding water supply pipe P and pump 10. The pneumatic pipe or line 12 may be disposed substantially vertically, directly between the pipe P and overlying pump 10, or may be at some angle other than vertical, depending upon the installation configuration of the pipe P and corresponding pump 10. Each of the pneumatic pumps P can be equipped with a pneumatic filter 14, as shown in FIGS. 2 and 3, to further prevent entry of undesirable foreign matter (e.g., particulate matter, microbes, etc.) into the water supply network N through the pumps 10 and their connecting lines or pipes 12.

The pumps 10 are installed downstream of the water supply reservoir R, between the reservoir R and the end user points E in the system. In a simple system comprising only a single water supply pipe P, a single pneumatic pump 10 may be all that is needed. However, a pressure drop within the pipes P will not occur simultaneously throughout the entire network N. Thus, a plurality of such pumps P are preferably installed throughout the system in a relatively complex network N of pipes P, as shown in FIG. 1. (Only two such pneumatic pumps P are illustrated in FIGS. 1 and 2, for clarity in the drawings.)

Each of the pumps 10 is controlled by at least one fluid pressure sensor 16 installed upstream or downstream from the respective pump. Preferably, two such pressure sensors 16 are provided with each pump 10, as shown in FIGS. 1 and 2, with one of the sensors 16 installed upstream of the pump 10, i.e., between the water supply reservoir R and the pump 10, and another sensor 16 installed downstream of the pump 10. Thus, each pump 10 can be located between two such sensors 16. Each of the sensors 16 can be in communication with the corresponding water pipe P via an interconnecting pressure line 18 (FIG. 2) extending between the sensor 16 and the corresponding water pipe P. Although the sensors 16 are shown above a ground surface in the drawings, each of the sensors can be installed within a corresponding water pipe P (not shown). Any change in pressure within the pipe P at the location of the sensor 16 is detected by that sensor 16. Each of the sensors 16 communicates with the corresponding pneumatic pump 10 by some suitable electrical or electronic means, e.g., hard wire connection 20 or wireless system. Thus, if a pressure or average pressure in the water pipe P drops below a predetermined level, e.g., at least slightly below the surrounding pressure external to the pipe P, the sensor(s) 16 detect the pressure drop via their corresponding lines 18 and transmit a signal to start the corresponding pump(s) 10 via the interconnecting line 20 or other means. The pump(s) 10 then pump ambient atmospheric air into the pipe(s) P to increase the pressure therein above the ambient pressure external to the pipe(s) P, thus preventing incursion of foreign matter into the pipe(s) P through any breaks or openings therein.

FIG. 2 illustrates such a scenario, in which the roots of a tree T have damaged the pipe P and created an opening O1 in the pipe P. Another opening O2 is indicated at a joint in the pipe P. In the event that water leaks from these openings O1 and/or O2 to the extent that a significant pressure drop occurs within the pipe P, the system operates as described above to increase the pressure within the pipe P pneumatically by pumping atmospheric air into the pipe P to increase the pressure therein to a level above that of the ambient pressure immediately surrounding the pipe P.

FIG. 3 provides a detailed schematic illustration of a single pneumatic pump 10 connected to a water supply pipe P by an interconnecting pipe 12. In the event that water in the pipe P tends to flow up the connecting pipe 12 toward the pneumatic pump 10, a one-way check valve 22 can be provided in the connecting pipe 12 between the pneumatic pump 10 and the corresponding water supply pipe P, as shown in FIG. 3. The check valve 22 is oriented to allow airflow down the interconnecting pipe 12 from the pump 10 to the water supply pipe P, but to block or prevent flow in the opposite direction, i.e., up the interconnecting pipe 12 from the water supply pipe P toward the pneumatic pump 10. Thus, water pressure is maintained within the pipe P under normal conditions, as no water is permitted to flow outward through the pneumatic pumps 10.

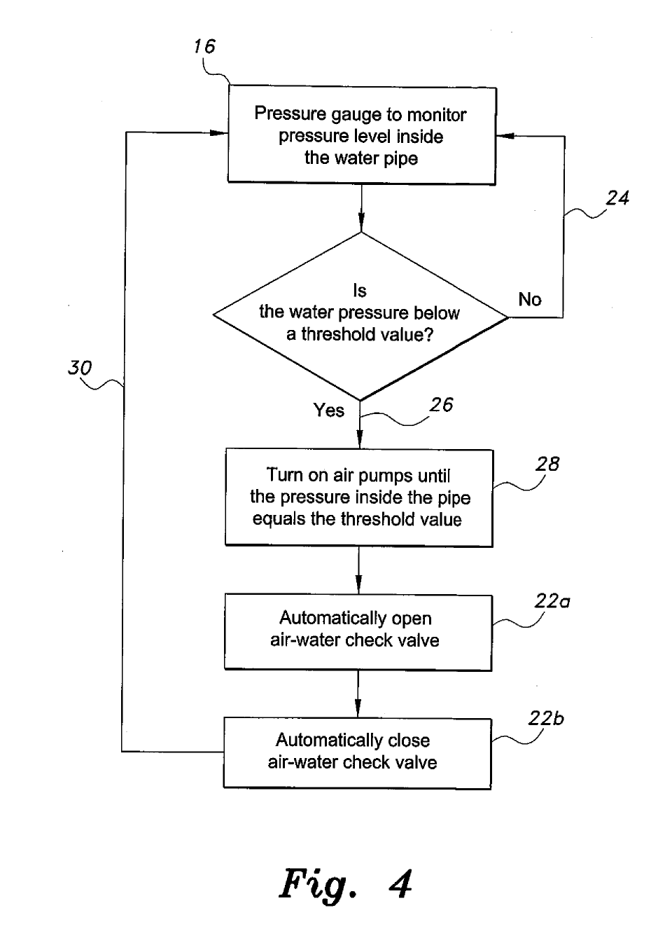

FIG. 4 of the drawings is a flow chart describing the essential steps in the operation of the system for preventing contaminant intrusion. The pressure gauge(s) or sensor(s) 16 continuously monitor the pressure within the water supply pipe(s), as described further above. So long as the pressure within the water supply pipe(s) remains at or above the predetermined threshold as indicated by the path 24 in FIG. 4, no signal is sent to the corresponding air pump(s). This is the case for all normal operation of the system. However, in the event that the pressure drops below the predetermined threshold, the pressure gauge(s) or sensor(s) 16 send(s) a signal(s) to the corresponding pump(s) to activate the pump(s), as shown by the signal path 26 of FIG. 4. Increased pneumatic pressure is provided by the pump(s) 10 until the total pressure within the pipe(s) P reaches a predetermined level at least equal to, and preferably somewhat higher, than the ambient pressure immediately surrounding the pipe(s) P, as indicated by the step 28. The resulting increased pressure within the interconnecting pipe(s) between the pneumatic pump(s) causes the corresponding one-way check valve(s) to open, as indicated by the open valve position 22a in FIG. 4. When suitable pressure has been reached within the pipe(s) P, as sensed or detected by the sensor(s) or gauge(s) 16, the check valve(s) automatically close, as indicated by the closed valve position 22b of FIG. 4. As this pressure is at least equal to, and preferably at least slightly higher than, the ambient pressure external to the water supply pipe(s), the sensor(s) or gauge(s) 16 sense this increased pressure as indicated by the higher pressure path 30 back to the sensor(s) or gauge(s) 16, thus causing the sensor(s) or gauge(s) 16 to shut off its/their signal(s) to the pneumatic pump(s), and to cease pump operation. This process may continue as long as necessary if a break continues to exist in the water supply pipe(s), until the water supply is shut down for repair or replacement of the defective pipe section(s).

Research for the above-described system was funded by the National Plan for Science, Technology and Innovation (MARIFAH)—King Abdulaziz City for Science and Technology—through the Science & Technology Unit at King Fahd University of Petroleum & Minerals (KFUPM)—the Kingdom of Saudi Arabia, award number 12-WAT2390.

It is to be understood that the present invention is not limited to the embodiments described above, but encompasses any and all embodiments within the scope of the following claims.

I claim:

1. A system for preventing contaminant intrusion in a water supply network having at least one water reservoir and a plurality of interconnected underground water supply pipes extending therefrom, the system comprising:
at least one pneumatic pump communicating with a corresponding one of the water supply pipes, the pump extending above a ground surface and selectively drawing air from the atmosphere and pumping the atmospheric air into the water supply pipes to maintain fluid pressure within the water supply pipes at a level greater than ambient; and
a one-way check valve disposed between the pump and the corresponding water supply pipes, the check valve permitting flow of air from the pump into the water supply pipe and preventing flow from the water supply pipe back to the pump.

2. The system for preventing contaminant intrusion in a water supply network according to claim 1, further comprising at least one fluid pressure sensor communicating with a corresponding one of the water supply pipes and a corresponding pneumatic pump, the fluid pressure sensor selectively controlling operation of the pump.

3. The system for preventing contaminant intrusion in a water supply network according to claim 2, further comprising a plurality of fluid pressure sensors, each of the fluid pressure sensors communicating with one or more of the water supply pipes and the at least one pneumatic pump.

4. The system for preventing contaminant intrusion in a water supply network according to claim 2, further comprising:
a first fluid pressure sensor disposed between the water reservoir and the pneumatic pump; and
a second fluid pressure sensor disposed opposite the first fluid pressure sensor, the pneumatic pump being disposed between the first fluid pressure sensor and the second fluid pressure sensor.

5. The system for preventing contaminant intrusion in a water supply network according to claim 1, further comprising a water supply network in combination therewith.

6. The system for preventing contaminant intrusion in a water supply network according to claim 1, further comprising a plurality of pneumatic pumps communicating with the water supply pipes.

7. The system for preventing contaminant intrusion in a water supply network according to claim 1, further comprising an air filter connected to the pneumatic pump.

8. A system for preventing contaminant intrusion in a water supply network having at least one water reservoir and a plurality of interconnected underground water supply pipes extending therefrom, the system comprising:
at least one pneumatic pump communicating with a corresponding one of the water supply pipes, the pump selectively drawing air from the atmosphere and pumping the atmospheric air into the water supply pipes to maintain fluid pressure within the water supply pipes at a level greater than ambient; and
at least one fluid pressure sensor communicating with a corresponding one of the water supply pipes and with a corresponding pneumatic pump, the fluid pressure sensor selectively controlling operation of the pump.

9. The system for preventing contaminant intrusion in a water supply network according to claim 8, further comprising a one-way check valve disposed between the pump and the corresponding water supply line, the check valve permitting flow of air from the pump into the water supply pipe and preventing flow from the water supply pipe back to the pump.

10. The system for preventing contaminant intrusion in a water supply network according to claim 8, further comprising a water supply network in combination therewith.

11. The system for preventing contaminant intrusion in a water supply network according to claim 8, further comprising a plurality of fluid pressure sensors, each of the fluid pressure sensors communicating with one or more of the water supply pipes and the at least one pneumatic pump.

12. The system for preventing contaminant intrusion in a water supply network according to claim 8, further comprising:
a first fluid pressure sensor disposed between the water reservoir and the pneumatic pump; and
a second fluid pressure sensor disposed opposite the first fluid pressure sensor, the pneumatic pump being disposed between the first fluid pressure sensor and the second fluid pressure sensor.

13. The system for preventing contaminant intrusion in a water supply network according to claim 8, further comprising a plurality of pneumatic pumps communicating with the water supply pipes.

14. The system for preventing contaminant intrusion in a water supply network according to claim 8, further comprising an air filter connected to the pneumatic pump.

15. A water supply network system, comprising:
a water supply network having at least one water reservoir and a plurality of interconnected water supply pipes extending therefrom; and
at least one pneumatic pump communicating with a corresponding one of the water supply pipes, the pump selectively drawing air from the atmosphere and pumping the atmospheric air into the water supply pipes to maintain fluid pressure within the water supply pipes at a level greater than ambient.

16. The water supply network system according to claim 15, further comprising:
a one-way check valve disposed between the pump and the corresponding water supply line, the check valve permitting flow of air from the pump into the water supply pipe and preventing flow from the water supply pipe back to the pump; and
at least one fluid pressure sensor communicating with a corresponding one of the water supply pipes and with a corresponding pneumatic pump, the fluid pressure sensor selectively controlling operation of the pump.

17. The water supply network system according to claim 16, further comprising a plurality of fluid pressure sensors, each of the plurality of fluid pressure sensors communicating with at least one of the water supply pipes and the at least one pneumatic pump.

18. The water supply network system according to claim 16, further comprising:
a first fluid pressure sensor disposed between the water reservoir and the pneumatic pump; and
a second fluid pressure sensor disposed opposite the first fluid pressure sensor, the pneumatic pump being disposed between the first fluid pressure sensor and the second fluid pressure sensor.

19. The water supply network and system according to claim 15, further comprising a plurality of pneumatic pumps communicating with the water supply pipes.

20. The water supply network and system according to claim 15, further comprising an air filter connected to the pneumatic pump.
